(19) United States
(12) Patent Application Publication
(10) Pub. No.: US 2011/0048085 A1
(43) Pub. Date: Mar. 3, 2011

(54) Temporary slurry sprayed permeable cover design for erosion protection and passive biofiltration of methane, volatile organic compounds (VOCs) and odors from area sources.

(75) Inventor: H Keith Otsuki, Livermore, CA (US)

(73) Assignee: Mr. H Keith Otsuki, Livermore, CA (US)

(21) Appl. No.: 12/552,849

(22) Filed: Sep. 2, 2009

(51) Int. Cl. C05F 11/00

(52) U.S. Cl. 71/6

(57) ABSTRACT

This invention is a permeable cover layer for the control of methane, volatile organic compounds (VOCs) and/or odor causing compounds. It is designed to control emissions from area sources such as: composting operations (household and animal wastes), anaerobic digesters, organic sludge drying operations, waste storage operations, contaminated soils storage or treatment operations. The control is achieved through a combination of activated carbon adsorption and passive (i.e. no active ventilation) biofiltration.

### DRAWINGS

Not applicable

### OATH OR DECLARATION

Attached.

### SEQUENCE LISTING (IF ANY).

Not applicable

A temporary slurry sprayed permeable cover design for erosion protection and passive biofiltration of methane, volatile organic compounds (VOCs) and odors from area sources.

### CROSS REFERENCE TO RELATED APPLICATIONS

none

### STATEMENT OF FEDERALLY SPONSORED RESEARCH/DEVELOPMENT

Not applicable

### REFERENCE TO A SEQUENCE LISTING, A TABLE, OR A COMPUTER PROGRAM LISTING COMPACT DISC APPENDIX

Not applicable

### BACKGROUND OF THE INVENTION

This invention pertains to the field of environmental pollution control. It applies specifically to a combination of erosion protection, odor abatement and control of methane and/or volatile organic compound (VOC) emissions from area sources where impermeable covers would impede a desired process. These sources would include: composting operations (household and animal wastes), sludge drying operations, anaerobic digesters, waste storage operations, contaminated soils storage or treatment.

Prior art for erosion protection, odor abatement and control of volatile organic compound (VOC) emissions from area sources varies based on type of operation, but can generally be classified as: (1) active systems that use fans and/or structures to capture emissions and duct the emissions through control equipment, (2) impervious covers that prevent emissions by containment, (3) permeable covers that control emissions by biological oxidation (respiration), or (4) erosion protection alone.

Active systems have high capital costs to construct fans, ducting, and/or containment structure and high operating costs for maintenance and operation fans, ducting and pollution control equipment. Composting, sludge drying, and contaminated soils storage or treatment are usually spread over large areas and the cost of erecting a containment structure is often prohibitive. A common strategy is to install the ventilation system in the floor, so that the compost, sludge or contaminated soil is placed above the ventilation system and the ventilation system run under vacuum. This induces a downward flow of air through the material. Capture efficiency is limited by the physical dimensions of the material piles and the amount of vacuum applied. The system is also required to include run-off controls to prevent particulate contamination in storm water run-off water.

The prior art for impervious covers include a number of different covering materials. The primary problem with impervious covers is that they are impervious. They inhibit the transfer of oxygen needed for aerobic biological processes; the transfer of water for drying operations; and the transfer of VOCs for aeration operations. The most common use is to meet daily cover requirements for landfill operations. Impervious covers are also often used to cover anaerobic digesters, particularly for larger units where biogas can be economically recovered. For smaller anaerobic digesters where biogas cannot be economically recovered, the biogas can present a safety hazard to workers that requires mitigation.

The prior art for permeable covers is a number of other biofilter or biovent designs. Most of these are as components of either active ventilation systems or passive systems where air flow is directed to the biofilter (e.g. part of a composter design or landfill cap design). The most similar prior arts are: (1) the practice of using previously composted material for the uppermost layer of the compost pile and (2)the practice of using chopped hay, straw or other vegetative material as a permeable cover for anaerobic digesters to control odor emissions. The practice of using previously composted material only controls VOC and odor emissions and does not control erosion or methane emissions. The effectiveness of this practice is limited by the equipment operators ability to spread the cover material evenly to maintain the minimum cover thickness. The limitations using chopped vegetative material covers are: (1) they do not control erosion, (2) they do not control emissions of methane, (3) they don't reliably achieve high control efficiencies, (4) they typically require 4-10 inches of bed thickness and lose about half of their bed thickness within about 4 months due to settling and erosion, and (5) they are generally limited to level surfaces (i.e. difficult to maintain on sloped surfaces).

The problems with erosion control only/no control depends on the compounds being emitted from the source material and may include: (1) that neighbors and the environment exposed to the nuisance of odors, (2) neighbors may be exposed to chemicals that may acutely or chronically toxic, (3) the environment will be exposed to additional VOC emissions that contribute to the formation of photochemical oxidants (smog), and (4) the environment will be exposed to additional emissions of methane, which is a known greenhouse gas.

BRIEF SUMMARY OF THE INVENTION

This invention is a temporary permeable cover created by spraying a slurried mixture evenly over the source material. This cover adheres to the shape of the source material creating a custom cover fitted over the source and the cover thickness can be controlled as a primary design variable for controlling air emissions. The basic components of the cover are shredded vegetative material (mulch), a polymeric binder, an adsorbant material, and an active biological culture. The shredded vegetative material and the polymeric binder provide the physical matrix of the cover. The polymeric binder holds the shredded vegetative material together to minimize settling and to control the erosive effects of wind and rain. The adsorbant locally concentrate certain chemicals making them more available to the biological culture and retard the transport of the chemicals across the cover increasing the residence time and providing greater opportunity for the biological culture to metabolize them. The biological cultures used are selected for their ability to metabolize the compounds being emitted by the source material. Additional components may include adsorbents nutrients and dyes. The components are mixed with water to form an aqueous slurry.

### BRIEF DESCRIPTION OF THE SEVERAL VIEWS OF THE DRAWING

Not applicable

### DETAILED DESCRIPTION OF THE INVENTION

The primary components of the slurry are shredded vegetative material (mulch), an active biological culture, a polymeric binder and water. The slurry may also contain other ingredients including adsorbents (e.g. activated carbon), nutrients, dyes and other additives. The slurry is sprayed to form a uniform layer covering the source material. The presence or absence of dye can be used to provide a visual contrast for the operator to assure complete coverage. One of the key operational parameters is the cover thickness and multiple layers may be used.

The shredded vegetative material (mulch) provides the physical matrix for the cover, helps maintain the moisture level, and creates the physical environment to support the growth of the biological culture. The polymeric binder holds the matrix together and reduces the erosion and compaction of the cover. Together, the shredded vegetative material (mulch) and the polymeric binder provide a physical barrier to protect the underlying source material from erosion by wind and rain. This enables the cover to be used on sloped surfaces (e.g. piles and windrows).

Long term control of air emissions from the underlying source material is through aerobic metabolic oxidation by a biological culture. The slurry may not need to be inoculated, as the mulch likely provides an adequate mixed biological culture. Inoculation does improve the ability to establish consistent biological populations and allows selection of a culture adept at controlling the compounds being emitted by the source material, (e.g. use of a methanotrophic culture to control methane emissions from a methanogenic material, or use of a sulfur-oxidizing bacteria to control hydrogen sulfide emissions). Nutrients may be added to the slurry to encourage the rapid growth of the bacterial culture. The rate of metabolic oxidation is generally proportional to biomass of the culture. An incubation period may be required to establish a significant initial biomass for the cover.

Adsorbents, such as activated carbon, may also be added for adsorptive properties. Volatile organic compounds(VOC) and other odor-causing chemicals adsorb to the surface of activated carbon. The addition of activated carbon has four effects:
1. provides immediate, short term control of emitted compounds,
2. locally concentrates the emitted compounds making them more available to biological control,
3. retards the transport of compounds through the cover and therefore increases the residence time of the emitted compounds within the physical matrix of the cover (reducing the required cover thickness) providing the biological culture more opportunity to metabolize them, and
4. provides growth sites for bacterial cultures.

Dyes may be added to provide the operator visual evidence of coverage. Different dyes may be used to differentiate between different layers.

What is claimed is:

1. A permeable biofiltering cover layer formed by spreading a composition consisting of: (a) a bulking material comprising a fibrous material such as mulch, (b) a polymeric binder, (c) a bacterial culture, and (d) other additives, including adsorbents, dyes, and nutrients, the composition when mixed with an aqueous carrier forming a sprayable aqueous slurry suitable for providing a cover layer over a selected material to control emissions of volatile organic compounds (VOCs) and to provide physical protection against erosion.

2. A permeable biofiltering cover layer formed by spreading a composition consisting of: (a) a bulking material comprising a fibrous material such as mulch, (b) a polymeric binder, (c) a bacterial culture, and (d) other additives, including adsorbents, dyes, and nutrients, the composition when mixed with an aqueous carrier forming a sprayable aqueous slurry suitable for providing a cover layer over a selected material to control emissions of odor causing compounds and to provide physical protection against erosion.

3. A permeable biofiltering cover layer formed by spreading a composition consisting of: (a) a bulking material comprising a fibrous material such as mulch, (b) a polymeric binder, (c) a bacterial culture, and (d) other additives, including adsorbents, dyes, and nutrients, the composition when mixed with an aqueous carrier forming a sprayable aqueous slurry suitable for providing a cover layer over a selected material to control emissions of methane and to provide physical protection against erosion.
